(19) United States
(12) Patent Application Publication
(10) Pub. No.: US 2015/0213820 A1
(43) Pub. Date: Jul. 30, 2015

(54) MAGNETIC RECORDING HEAD HAVING THERMAL FLY HEIGHT CONTROL ELEMENT WITH NEAR ZERO MAGNETOMOTIVE FORCE

(71) Applicant: HGST Netherlands B.V., Amsterdam (NL)

(72) Inventors: Venkatesh Chembrolu, San Jose, CA (US); Wen-Chien D. Hsiao, San Jose, CA (US); Edward H.P. Lee, San Jose, CA (US); Xinjiang Shen, Fremont, CA (US)

(73) Assignee: HGST NETHERLANDS B.V., Amsterdam (NL)

(21) Appl. No.: 14/166,780

(22) Filed: Jan. 28, 2014

(51) Int. Cl. G11B 5/60

(52) U.S. Cl. CPC G11B 5/607

(57) ABSTRACT

A magnetic recording head with thermal fly height control, wherein the heating element is configured to eliminate magnetic field effects on the writing pole, which would cause otherwise cause non-symmetric writing or pole erasure. Non-symmetric writing is a phenomenon wherein magnetic writing favors one direction over another, thereby causing a timing shift in recorded data. The pole erasure is a phenomenon wherein the erasure would occur even without write current. The heating element can be formed as a plurality of electrically conductive layers separated by a non-magnetic, electrically insulating layer such as alumina. The electrically conductive layers are configured so that current flows in opposite directions through each of the electrically conductive layers such that any magnetic field generated by the current flow through one electrically conductive layer is cancelled out by a magnetic field from another electrically conductive layer.

### FIELD OF THE INVENTION

The present invention relates to magnetic data recording and more particularly to a thermally assisted fly height control magnetic recording head that eliminates heating element induced magnetic field effects on the write pole, thereby reducing non-symmetric writing or data erasure.

### BACKGROUND

At the heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has a media facing surface (MFS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When current flows through the coil, a resulting magnetic field causes a magnetic flux to flow through the coil, which results in a magnetic write field emitting from the tip of the write pole. This magnetic field is sufficiently strong that it locally magnetizes a portion of the adjacent magnetic media, thereby recording a bit of data. The write field then, travels through a magnetically soft under-layer of the magnetic medium to return to the return pole of the write head.

A magnetoresistive sensor such as a Giant Magnetoresistive (GMR) sensor or a Tunnel Junction Magnetoresistive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the magnetic media.

### SUMMARY

A magnetic recording head is provided that includes a magnetic write element, a magnetic read element and a thermal heating element. The thermal heating element includes a plurality of electrically conducive layers separated by an electrically insulating layer, the electrically conductive layers being configured such that electrical current flows through the electrically conductive layers in opposite directions.

For example, the thermal heating element can include first and second electrically conductive layers with a layer of electrically insulating material sandwiched between them. The first and second electrically conductive layers can be electrically connected with one another at one end, for example by a connection stud. Electrical lead pads can be connected with each of the electrically conductive layers at a second end, opposite the connection stud, for providing an electrical current to the thermal heating element.

At least one of the electrically conductive layers can be a material that is chosen to produce Joule heating when an electrical current passes through it. By forming the first and second electrically conductive layers such that current flows in opposite directions, any magnetomotive force produced by one electrically conductive layer will advantageously be cancelled out by a magnetomotive force from the other electrically conductive layer.

These and other features and advantages of the invention will be apparent upon reading of the following detailed description of the embodiments taken in conjunction with the figures in which like reference numeral indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is a view of a media facing surface of a slider, illustrating the location of a magnetic head thereon;

FIG. 3 is a side, cross-sectional view of a magnetic recording head;

FIG. 4 is a top down view of a thermal heating element as seen from line 4-4 of FIG. 3;

FIG. 5 is a cross sectional view of the thermal heating element as seen from line 5-5 of FIG. 4; and

FIG. 6 is a side cross sectional view of the thermal heating element as seen from line 6-6 of FIG. 4.

### DETAILED DESCRIPTION

The following description is of the best embodiments presently contemplated for carrying out this invention. This description is made for the purpose of illustrating the general principles of this invention and is not meant to limit the inventive concepts claimed herein.

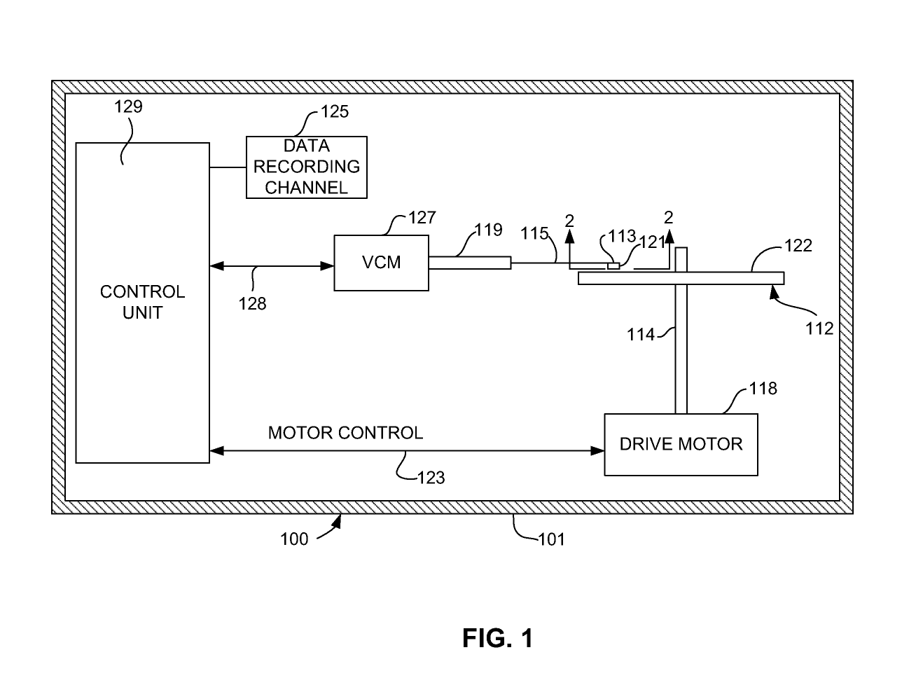

Referring now to FIG. 1, there is shown a disk drive 100. The disk drive 100 includes a housing 101. At least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk 112 rotates, slider 113 moves in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases the slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by the controller 129.

During operation of the disk storage system, the rotation of the magnetic disk 112 generates an air bearing between the slider 113 and the disk surface 122, which exerts an upward force or lift on the slider. The air bearing thus counter-balances the slight spring force of the suspension 115 and supports the slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage, means and a microprocessor. The control unit 129 generates control signals to control various system operations such as drive motor control signals on line 123 and head position and seek control signals on line 128. The control signals on line 128 provide the desired current profiles to optimally move and position the slider 113 to the desired data track on the media 112. Write and read signals are communicated to and from write and read heads 121 by way of recording channel 125.

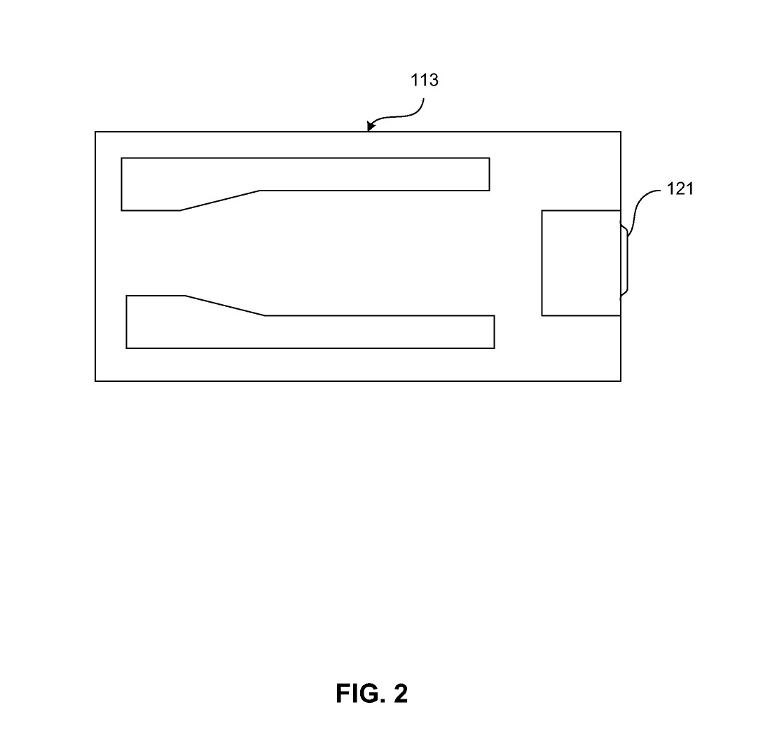

With reference to FIG. 2, the orientation of the magnetic head 121 in a slider 113 can be seen in more detail. FIG. 2 is a view of the slider 113 as seen from the media facing surface, and as can be seen, the magnetic head 121, including an inductive write head and a read sensor, is located at a trailing edge of the slider 113. The above description of a typical magnetic disk storage system and the accompanying illustration of FIGS. 1 and 2 are for representation purposes only. It should be apparent that the disk storage system may contain a large number of disks and actuators, and each actuator may support a number of sliders.

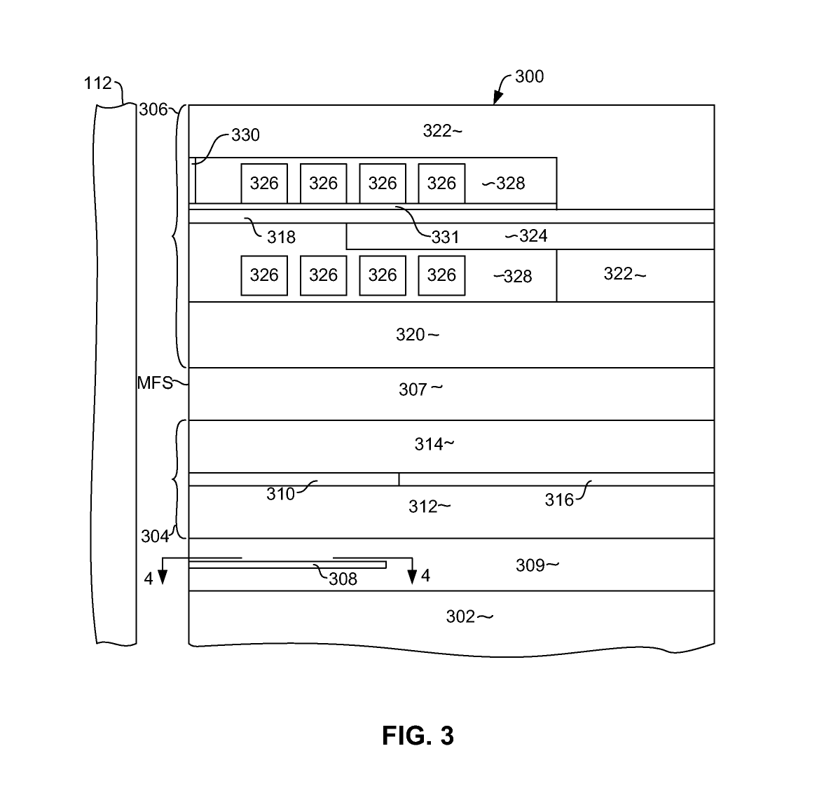

FIG. 3 shows a magnetic head 300 formed on a substrate 302. The substrate 302 can be a dielectric material such as alumina formed on a body of a slider 113 (FIG. 2). The magnetic head 300 includes a magnetic read element 304, a magnetic write element 306 and a thermal heating element 308 for thermal fly height control. The heating element 308 can be embedded in a non-magnetic, electrically insulating material such as alumina 309. The purpose and function of the thermal fly height control and specific structure of the heating element 308 will be described in greater detail herein below. A non-magnetic, dielectric layer 307 can be included to separate the magnetic read and write elements 304, 306.

The read element 304 can include a magnetoresistive sensor 310 sandwiched between first and second magnetic shields 312, 314 and can be embedded in a dielectric material 316. The magnetoresistive sensor 310 can be giant magnetoresistive sensor (GMR) or a tunnel junction magnetoresistive sensor (TMR).

The magnetic write element 306 can include a magnetic write pole 318 that extends to a media facing surface MFS, and can also include a magnetic return pole 320, which can be magnetically connected with the write pole 318 by a magnetic back gap layer 322 located away from the media facing surface MFS and a magnetic shaping layer 324 that is magnetically connected with the write pole 318 and helps to channel magnetic flux to the write pole 318. The write element 306 has a non-magnetic, electrically conductive coil 326 that can pass below and above the write pole 318. The write coil 326 can be embedded in a non-magnetic dielectric layer 328. When a current flows through the write coil 326, a magnetic field is induced that causes a magnetic write field to flow through the write pole 318, return pole 320, back gap layer 322 and shaping layer 324. This causes a magnetic write field to emit from the write pole 318 in order to write a magnetic bit onto an adjacent magnetic media 112. The write element 306 can also include a trailing magnetic shield 330, which may be connected with a trailing magnetic return pole 332, and which is separated from the write pole by a non-magnetic trailing gap layer 331. The trailing magnetic shield 330 can help to increase field gradient, thereby improving magnetic performance.

Magnetic spacing between the magnetic media 112 and the read and write elements 304, 306 has a large impact on magnetic performance. The magnetic signal drops off exponentially with distance, so minimizing magnetic spacing is critical to providing sufficient write field to write to the media 112 as well as ensuring sufficient signal strength to read data from the media 112 by the read sensor 310. On the other hand, the magnetic head 300 should not become so close to the media 112 that it actually contacts the media 112. Such head disk contact can damage the sensor 310 as well as leading to data loss.

One way to adjust and control the magnetic spacing for optimal performance is through active thermal fly height control. In such as system, the thermal heating element 308 can be used to heat the surrounding structure. The resulting thermal expansion of the read and write heads 304, 306 causes them to protrude toward the media 112 in a controllable fashion. Heating elements can be formed of an electrically conductive material having a sufficiently high electrical resistance that Joule heating will cause them to heat up when an electrical current flows through the heating element. However, a problem presented by such heating elements is that the electrical current used to heat the heating element also results in a magnetic field (magnetomotive force) being generated. This magnetic field can be mistakenly read by the read sensor 310 and can even inadvertently lead to undesirable magnetization of the magnetic media 112, thereby resulting in signal noise. The magnetic field from the heating element 308 can inadvertently magnetize the write pole, thereby causing a magnetic field from the write pole 318 to undesirably erase data from the magnetic media, a phenomenon known as “pole erasure”. Further, magnetic fields from the heating element can cause an asymmetrical signal to be recorded to the magnetic media 112.

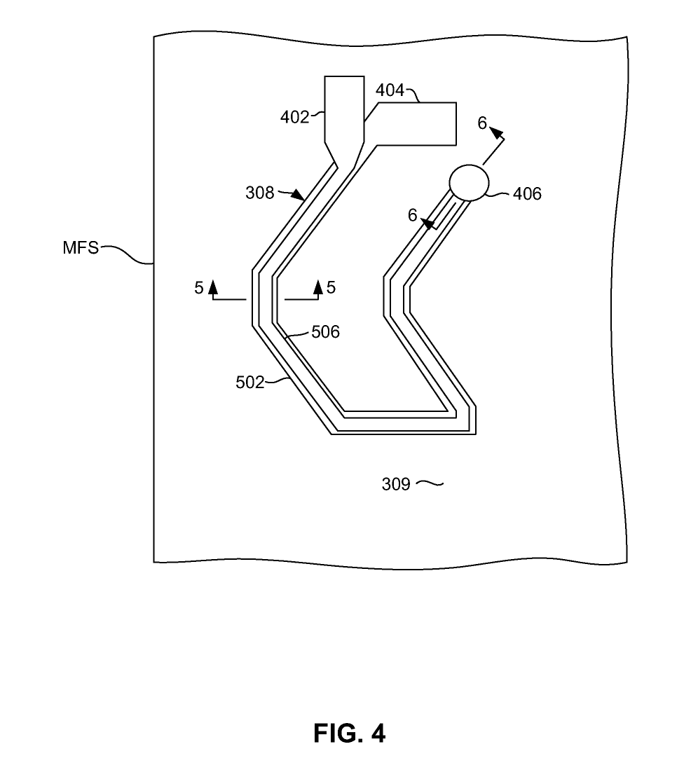

The present invention solves this problem through use of a novel heating element design 308 that will be further described herein below with reference to FIGS. 4, 5 and 6. FIG. 4 shows a top down view of a possible configuration of the thermal heating element 308 as seen from line 4-4 of FIG. 3. The thermal heating element 308 can have a bent shape as shown in FIG. 4, but could have some other shape as well. The heating element 308 can also include first and second lead pads 402, 404, and an electrically conductive connection stud 406.

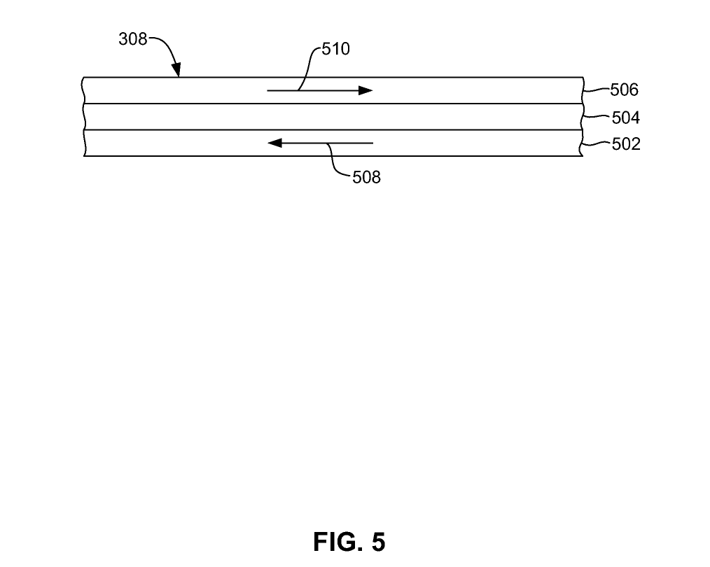

FIG. 5 shows a cross sectional view of a portion of the heating element 308 as seen from line 5-5 of FIG. 4. As shown in FIG. 5, the heating element 308 is constructed as a multi-layer structure having first and second electrically conductive layers 502, 506 that are separated by an electrically insulating, dielectric material 504 such as alumina or some other suitable material. The electrically conductive layers 502, 506 are configured such that current flowing through one layer 502 flows in an opposite direction to that of the other layer 506, as indicated by arrows 508, 510.

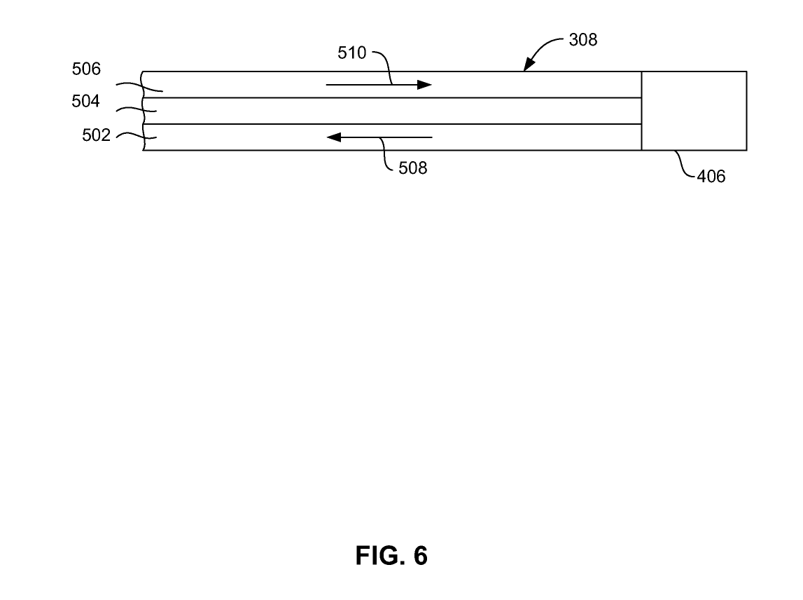

FIG. 6 shows a cross sectional view of the connection stud 406 as seen from line 6-6 of FIG. 4 and shows how the connection stud 406 can electrically connect the electrically conductive layers 502, 506 at an end of the heating element 308 opposite the leads 402, 404 (FIG. 4). This, therefore, allows the currents 508, 510 to be in opposite directions when a current is applied through the lead pads 402, 404 (FIG. 4).

By causing the currents 508, 510 to flow in opposite direction, the magnetic field emitting from the conductive layers 508, 510 cancel each other out. Therefore, the heating element 308 emits no (or very little) magnetic field. This, therefore, vastly decreases the signal noise resulting from the heating element 308.

In one embodiment, one of the layers (e.g. 506) can be a material intended to provide Joule heating. The other element 502 need not be constructed to contribute to heating, but could be constructed merely to provide a current return path. To this end, one layer (e.g. 506) can be a material such as NiFe, having an electrical resistance that is sufficient to provide heating. The other layer 502 can be a material such as Cu, and as shown in FIG. 4 the layer 502 can have a greater width or cross section to facilitate current flow.

Alternatively, the layers 502, 506 can be constructed of the same material and could be constructed such that they both contribute to Joule heating. For example, the conductive layers 502, 506 can both be formed of NiFe.

While various embodiments have been described above, it should be understood that they have been presented by way of example only and not limitation. Other embodiments falling within the scope of the invention may also become apparent to those skilled in the art. For example, while the magnetic head 300 (described above) has been described with reference to use in a magnetic disk drive system, the magnetic head 300 could be used in other applications as well, such as in a magnetic tape drive system. Thus, the breadth and scope of the invention may also become apparent to those skilled in the art. The breadth and scope of the inventions should not be limited by any of the above-described exemplary embodiments, but should be defined only in accordance with the following claims and their equivalents.

1. A magnetic recording head, comprising:
a magnetic write element;
a magnetic read element; and
a thermal heating element, comprising:
a plurality of electrically conducive layers separated by an electrically insulating layer, the electrically conductive layers being configured such that electrical current flows through the electrically conductive layers in opposite directions;
wherein each of the electrically conductive layers is formed in a bent “U” shape, the bent “U” shape having a base and first and second leg portions, each of each of the first and second leg portion being bent relative to a plane that is parallel with a media facing surface of the magnetic recording head.

2. The magnetic recording head as in claim 1 wherein the oppositely directed electrical current causes resulting magnetic fields from one electrically conductive layer to cancel out a magnetic field from another electrically conductive layer.

3. The magnetic recording head as in claim 1 wherein the thermal heating element comprises:
a first electrically conductive layer, a second electrically conductive layer and a layer of non-magnetic, electrically insulating material sandwiched between the first and second electrically conductive layers.

4. The magnetic recording head as in claim 1 wherein at least one of the electrically conductive layers is a material selected to produce heat as a result of electrical current flowing there-through.

5. The magnetic recording head as in claim 1, wherein the thermal heating element comprises:
a layer of NiFe;
a layer of Cu; and
a layer of alumina sandwiched between the layer of NiFe and the layer of Cu.

6. The magnetic recording head as in claim 1, wherein the thermal heating element comprises:
a first electrically conductive layer, a second electrically conductive layer and an electrically conductive connection stud configured to electrically connect the first and second electrically conductive layers.

7. The magnetic recording head as in claim 6 wherein the electrically conductive connection stud is located at an end of the thermal heating element.

8. The magnetic recording head as in claim 6 wherein the electrically conductive connection stud is located at a first end of the thermal heating element, and further comprising a contact stud connected with each of the first and second electrically conductive layers at a second end of the thermal heating element.

9. The magnetic recording head as in claim 1, wherein the magnetic recording head has a media facing surface and wherein the thermal heating element is formed in the bent “U” shape in a plane that is perpendicular to the media facing surface.

10. The magnetic recording head as in claim 1, wherein the thermal heating element is in sufficiently close proximity to the read and write elements to cause a controllable thermal protrusion of the read and write elements.

11. A magnetic data recording system, comprising:
a housing;
a magnetic media movably held within the housing;
a magnetic recording head configured for movement relative to a surface of the magnetic media, the magnetic recording head further comprising:
a magnetic write element;
a magnetic read element; and
a thermal magnetic heating element, comprising:
a plurality of electrically conductive layers separated by an electrically insulating layer, the electrically conductive layers being configured such that electrical current flows through the electrically conductive layers in opposite directions;
wherein each of the electrically conductive layers is formed in a bent “U” shape, the bent “U” shape having a base and first and second leg portions, each of each of the first and second leg portion being bent relative to a plane that is parallel with a media facing surface of the magnetic recording head.

12. The magnetic data recording system as in claim 11, wherein the oppositely directed electrical current causes resulting magnetic fields from one electrically conductive layer to cancel out a magnetic field from another electrically conductive layer.

13. The magnetic data recording system as in claim 11, wherein the thermal heating element comprises:
a first electrically conductive layer, a second electrically conductive layer and a layer of non-magnetic, electrically insulating material sandwiched between the first and second electrically conductive layers.

14. The magnetic data recording system as in claim 11, wherein at least one of the electrically conductive layers is a material selected to produce heat as a result of electrical current flowing there-through.

15. The magnetic data recording system as in claim 11,
wherein the thermal heating element comprises:
a layer of NiFe;
a layer of Cu; and
a layer of alumina sandwiched between the layer of NiFe and the layer of Cu.

16. The magnetic data recording system as in claim 11, wherein the thermal heating element comprises:
a first electrically conductive layer, a second electrically conductive layer and an electrically conductive connection stud configured to electrically connect the first and second electrically conductive layers.

17. The magnetic data recording system as in claim 16, wherein the electrically conductive connection stud is located at an end of the thermal heating element.

18. The magnetic data recording system as in claim 16, wherein the electrically conductive connection stud is located at a first end of the thermal heating element, and further comprising first and second contact studs connected with each of the first and second electrically conductive layers at a second end of the thermal heating element.

19. The magnetic data recording system as in claim 11, wherein the thermal heating element is formed in the bend “U” shape in a plane perpendicular to the air bearing surface.

20. The magnetic data recording system as in claim 11, wherein the thermal heating element is in sufficiently close proximity to the read and write elements to cause a controllable thermal protrusion of the read and write elements.
